(19) United States
(12) Patent Application Publication
(10) Pub. No.: US 2025/0042179 A1
(43) Pub. Date: Feb. 6, 2025

(54) ADHESIVE TRANSFER COEFFICIENTS FOR ADHESIVE-BASED PRODUCTS

(71) Applicant: Iconex LLC, Duluth, GA (US)

(72) Inventor: Jim Price, Duluth, GA (US)

(21) Appl. No.: 18/365,772

(22) Filed: Aug. 4, 2023

(51) Int. Cl. B41J 3/407; C09J 7/40; G09F 3/02

(52) U.S. Cl. CPC B41J 3/4075; C09J 7/40; G09F 3/02; C09J 2203/334; C09J 2301/208; C09J 2301/312; G09F 2003/0201; G09F 2003/0208; G09F 2003/023

(57) ABSTRACT

Adhesive-based products are manufactured via a plurality of stations of a press. During manufacturing, at least three stations deposit a layer of adhesive on backsides of the substrate. Each layer is stacked upon a previous deposited layer of adhesive. A transfer coefficient associated with a ratio of transferring the adhesive from a print element of a station to the substrate has a rate of increase between the second to the third layer of adhesive and the first and second layer of adhesive that exceeds the rate of increase between the first layer of adhesive and the substrate. This results in a coat-weight percentage increases in the second and third layers that exceeds the coat weight percentage increase in the first layer. Each product exhibits increased bonding strength to surfaces of objects from a bonding strength associated with a two-layered adhesive product.

### BACKGROUND

A plethora of adhesive-based products exist in the industry. For example, labels use adhesive to stick to surfaces. One challenge in transferring adhesive to a backside of a label during manufacturing is achieving a sufficient coat weight of the adhesive on the label substrate when the adhesive is transferred from a printing element to the substrate. However, adhesive remains on the printing element during manufacturing such that a desired coat weight on the substrate's backside becomes challenging.

The ratio of adhesive transferred from the printing element to the substrate is referred to as an adhesive transfer coefficient. A higher transfer coefficient results in a higher coat weight on the adhesive-based product.

The higher the coat weight that remains on the substrate of a product the greater the adhesive bond the product will have to an object's surface. Thus, higher adhesive transfer coefficients are needed to improve the adhesive coat weights of adhesive-based products and thereby improve the adhesive-bond strength of the products to surfaces.

### SUMMARY

In various embodiments, methods, and systems for increasing adhesive transfer coefficients during manufacturing of adhesive-based products are presented. In an embodiment, a label produced by the methods and/or systems is presented; the label includes an increased adhesive coat weight from what is available with conventional label manufacturing techniques and thus the label exhibits improved adhesive bonding characteristics over conventional labels.

Specifically, and in an embodiment, adhesive-based products are manufactured via a plurality of stations of a press. During manufacturing, at least two stations deposit a layer of adhesive on backsides of the product's substrate. Each subsequent layer is stacked upon a previous deposited layer of adhesive. A transfer coefficient associated with a ratio of transferring the adhesive from a print element of a station to the substrate has a rate of increase between the first and second layer of adhesive that exceeds a rate between the unprinted substrate and the first layer of adhesive. This results in a coat weight percentage increase in the second layer that exceeds the coat weight percentage increase in the first layer. All subsequent layers of adhesive applied will all enjoy this enhanced transfer coefficient and will exhibit coat weight percentage increases over the first applied adhesive layer. Each product exhibits increased bonding strength to surfaces of objects from a bonding strength associated with a single layered adhesive product. A two-layered product will have higher bonding strength than a single-layered adhesive product. A three-layered adhesive product will have higher bonding strength than a two-layered adhesive product. A four-layered adhesive will have higher bonding strength than a three-layered adhesive product, and so on.

In an embodiment, the substrate is processed through the press in two passes on the substrate. In an embodiment, the substrate is processed through the press in a single pass on the substrate. In an embodiment, the adhesive-based product is an adhesive label.

### BRIEF DESCRIPTION OF THE DRAWINGS

FIG. 1A is a diagram of system for increased adhesive transfer coefficients during manufacturing of an adhesive-based product, according to an example embodiment.

FIG. 1B is a diagram of another system for increased adhesive transfer coefficients during manufacturing of an adhesive-based product, according to an example embodiment.

FIG. 1C is a table illustrating example adhesive coat weights by passes and by station of the system of FIG. 1A, according to an example embodiment.

FIG. 2 is a diagram of a station for the system of FIG. 1A or the system of FIG. 1B, according to an example embodiment.

FIG. 3 is a diagram of a label with an increased adhesive coat weight produced by the system 1A or the system 1B, according to an example embodiment.

FIG. 4 is a diagram of a method for manufacturing adhesive-based products with an increased adhesive transfer coefficient and thus a higher adhesive coat weight, according to an example embodiment.

### DETAILED DESCRIPTION

Conventional adhesive-based products are manufactured using a press. The press includes a plurality of stations, each station includes a printing unit capable of depositing coatings on substrates of the products and/or imaging colors, designs, or indicia on the substrates. The coatings can include thermal-imaging receptive coatings, adhesive coatings, release coatings, primer coatings, etc.

Typically, a web associated with the substrate is unwound from a roll and fed to the stations of the press. Once a last station is reached, the web is rewound. Conventional adhesive-based products use one to two stations of the press to deposit adhesive on a backside of the substrate during a single pass of the stations.

Anilox rollers are used to transfer adhesive to a printing element at an adhesive station of the press. The printing element deposits the adhesive onto a backside surface of the substrate. The ratio of adhesive that remains on the substrate versus what was originally on the printing element is referred to as the adhesive transfer coefficient. When transfer coefficients are higher, the adhesive coat weight on the substrate is higher, and when the adhesive coat weight increases, the adhesive bonding characteristics/strength increase in the product.

Conventionally, coat weights using a single adhesive station and printing units achieve around 2-3 to 3-5 gsm (grams per square meter) on the substrate depending upon printing tooling choices. Conventional, coat weights using a single pass on the press with two adhesive stations or printing units achieve around 5-8 to 8-12 gsm depending upon printing tooling choices. Notably, using a second adhesive station results in coat weights that almost triple the coat weights associated with using a single adhesive station. The enhanced transfer coefficient remains constant from a single adhesive coating to a double adhesive coating.

Experimentation has discovered that the transfer coefficient improvement seen when applying a second layer of adhesive over a first layer is also present when applying a third adhesive layer over a second adhesive layer. For example, given a specific set of printing tooling, the first adhesive application would result in 2-3 gsm, the improved transfer coefficient of the second application of adhesive results in a higher additive coat weight of 4-8 gsm leading to a total coat weight following two applications of 6-11 gsm. A third application of adhesive will continue to benefit from the enhanced transfer coefficient derived from printing/depositing adhesive onto adhesive and therefore will also add 4-8 gsm leading to a total coat weight of 10-19 gsm following three applications of adhesive. The persisting enhanced transfer coefficient of printing adhesive onto an existing layer of adhesive should be sustainable for applications beyond three layers of adhesive and thus can be used as a path to attain higher and higher coat weights. The rate that the coat weight increases from the first to the second (and all subsequent) adhesive layer coatings illustrates an increased transfer coefficient from what was achieved with the first coating onto the substrate as evidenced by the more than double overall coat weight achieved with the second adhesive coating. Further proof of this enhanced transfer coefficient is evident by the more than triple coat weight achieved following the application of a third adhesive layer. Moreover, the rate of increase in the transfer coefficient and correspondingly the overall coat weight appears constant such that for each additional adhesive coating beyond three coatings the overall coat weight increases by approximately 4-8 gsm with a given set of printing tooling.

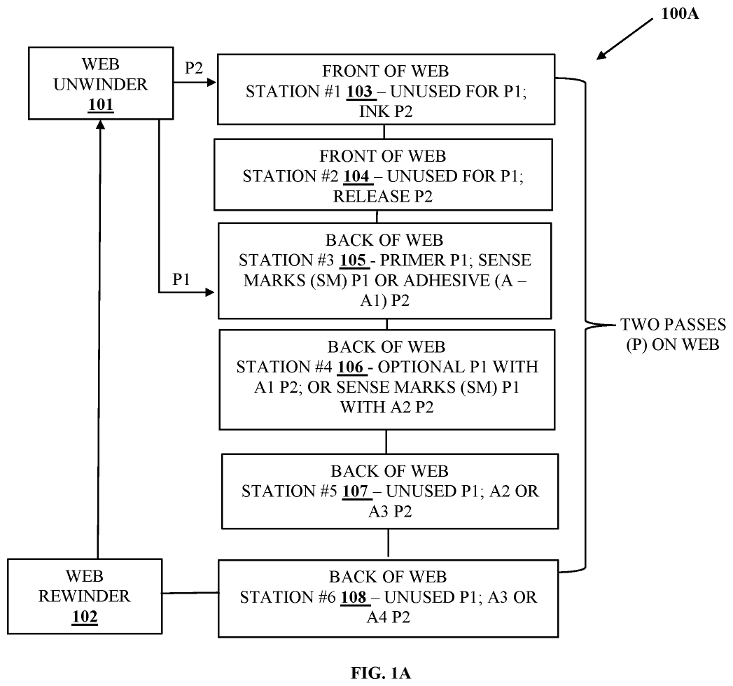

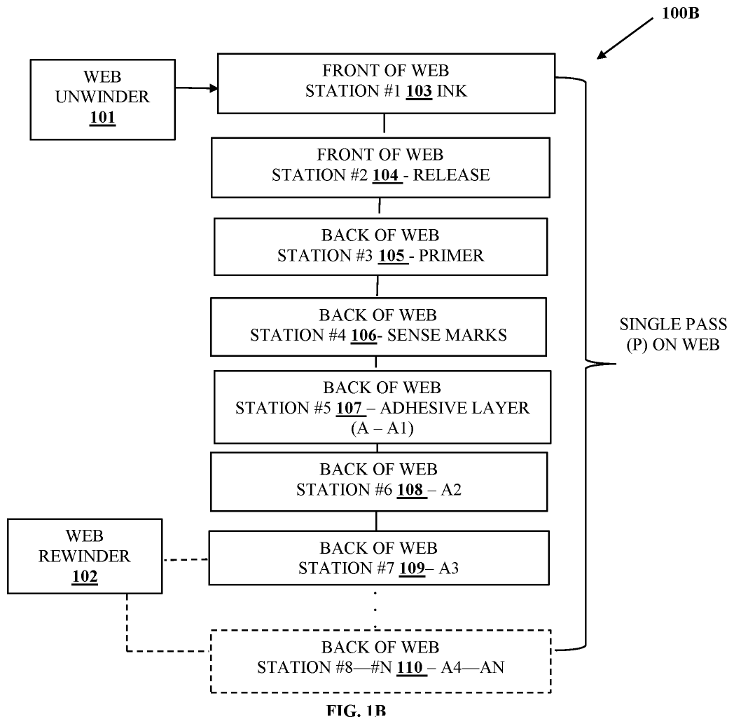

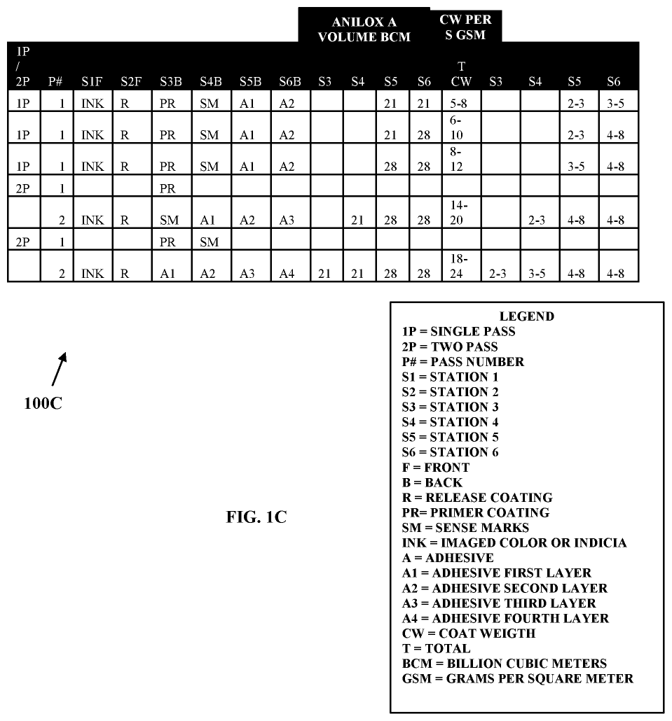

It is within this context that various embodiments are now discussed with references to the FIGS. FIG. 1A is a diagram of system 100A for increased adhesive transfer coefficients during manufacturing of an adhesive-based product, according to an example embodiment.

FIG. 1A is shown in simplified form with only those components necessary for understanding the teachings illustrated. It is noted that other components, less components, or more components from what is illustrated in FIG. 1A can be provided without departing from the teachings presented herein.

System 100A includes a web unwinder 101, a web rewinder 102, and six stations/printing units 103, 104, 105, 106, 107, and 108. Stations/Printing units (hereinafter just “stations”) 103 and 104 provide imaging or coatings to a front side of the web substrate. Stations 105-108 provide imaging of coatings to a backside of the web substrate. Collectively the web unwinder 101, web rewinder 102, and stations 103, 104, 105, 106, 107, and 108 represent a configuration of an adhesive-based product press.

As stated above, conventionally just two adhesive coatings were applied to the backside of the web substrate during a single pass of the web substrate through 6 stations. System 100A illustrates two passes on the web substrate to achieve three or more adhesive coatings on the backside of the web substrate.

Each station 103, 104, 105, 106, 107, and 108 is configurable such that the images and/or coating applied during a first pass can be different on a second pass. For example, a station on a first pass images or prints sense marks on the backside of the substrate, during a second pass the same station deposits an adhesive coating on the substrate.

Two configurations of system 100A are illustrated in FIG. 1A for multiple passes on the web substrate through the stations 103, 104, 105, 106, 107, and 108 for purposes of depositing at least three layers of adhesive on the backside of the substrate. In each of the configurations, station #1 103 and station #2 104 are unused for the first pass. In each configuration during a second pass, station #1 103 images or prints customer color or indicia on a front side of the web substrate; assuming the adhesive-based produce requires color or indicia. In each configuration during the second pass, station #2 104 deposits a release coating on the front side of the web substrate. For each configuration, the first pass begins at station #3 105.

In a first configuration of system 100A and during a first pass, station #3 105 deposit primer on a backside of the web substrate. Stations #4-#6 106-108 are unused during the first pass. In the second pass, station #1 103 images or prints any needed custom colors or indicia on the front side of the web substrate and station #2 104 deposits a release coating on the front side of the web substrate. Station #3 105 prints or images sense marks on a backside of the web substrate to delineate each individual adhesive-based product (e.g., label) defined in the web substrate during the second pass. Station #4 106 deposit a first layer of adhesive coating on the backside of the web substrate during the second pass. Station #5 107 deposits a second layer of adhesive coating on the backside of the web substrate during the second pass. Station #6 108 deposits a third layer of adhesive coating on the backside of the web substrate during the second pass.

In a second configuration of system 100A and during a first pass, station #3 105 deposits a primer on the backside of the web substrate. Station #4 106 prints or images sense marks on the backside of the web substrate during the first pass. Stations #5-#6 are unused during the first pass. In a second pass of the second configuration, station #1 103 images or prints any need customer colors or indicia on the front side of the web substrate. Station #2 104 deposits a release coating on the front side of the web substrate during the first pass. Station #3 105 deposits a first layer of adhesive coating on the backside of the web substrate during the second pass. Station #4 106 deposits a second layer of adhesive coating on the backside of the web substrate during the second pass. Station #5 107 deposits a third layer of adhesive coating on the backside of the web substrate during the second pass. Station #6 108 deposits a fourth layer of adhesive coating on the backside of the web substrate during the second pass.

It is noted that the two configurations for two passes of system 100A can include additional configurations. For example, and for a variation on the second configuration, station #6 108 is unused during the second pass and the adhesive-based product includes three layers of the adhesive coating instead of the four layers of adhesive coating illustrated. In another variation, and for the first configuration, station #5 107 is used during a second pass to apply a fourth layer of adhesive coating and, optionally, station 6# 108 is used during the second pass to apply a fifth layer of adhesive coating.

The layers of adhesive are layered on top of one another to create bumps in the adhesive on the backside of the web substrate. The bumps increase the thickness of the adhesive coating and create ridges, which increases the adhesive coat weight and correspondingly the adhesive bonding strength for the corresponding adhesive-based product. Experimentation has revealed that the average thickness in the adhesive for three layers of adhesive is approximately 38 microns whereas the average thickness for two layers of adhesive is 24 microns.

FIG. 1B is a diagram of another system 100B for increased adhesive transfer coefficients during manufacturing of an adhesive-based product, according to an example embodiment. Again, FIG. 1B is shown in simplified form with only those components necessary for understanding the teachings illustrated. It is noted that other components, less components, or more components from what is illustrated in FIG. 1B can be provided without departing from the teachings presented herein.

System 100B includes a web unwinder 101, station #1 103, station #2 104, station #3 105, station #4 106, station #5 107, station #6 108, station #7 109, optionally one or more additional stations #-8-#N 110, and web rewinder 102. System 100B illustrates a single pass on the web substrate during which at least three layers of adhesive are deposited on the backside of the web substrate.

In the single pass on the web substrate, station #1 103 images or prints any custom color or indicia needed by the corresponding adhesive-based product on the front side of the web substrate. Station #2 104 deposits a release coating on the front side of the web substrate. Station #3 105 deposits a primer on the backside of the web substrate. Station #4 106 prints or images sense marks on the backside of the web substrate. Station #5 107 deposits a first adhesive layer on the backside of the web substrate. Station #6 108 deposits a second adhesive layer on the backside of the web substrate. Station #7 109 deposits a third adhesive layer on the backside of the web substrate. Optionally, station(s) #8-#N 110 deposit four or more additional adhesive layers on the backside of the web substrate.

Again, three or more layers of adhesive create adhesive bumps and ridges in the adhesive on the backside of the web substrate. The adhesive thickness increases as does the adhesive coat weight which in turn increases the adhesive bonding strength of the adhesive-based products defined within the web substrate. For example, a label with three layers of adhesive is capable of adhering to recycled material whereas a label of less than three layers of adhesive is typically not capable of adhering to surfaces associated with recycled material.

FIG. 1C is a table 100C illustrating example adhesive coat weights by passes and by station of the system of FIG. 1A, according to an example embodiment. Conventional 1 pass systems that apply two layers of adhesives are illustrated as “1P” in table 100C whereas the two different configurations of system 100A are illustrated as “2P” in table 100C. Each of the two configurations for the two passes of system 100A are illustrated. The Anilox adhesive volume for the stations that apply a layer of adhesive is illustrated (i.e., shown in billions of cubic microns (BCM) in table 100C) as are the coat weights and the contribution each layer by station adds to the overall total coat weight.

Notably, both configurations of the two-passes of system 100A show markedly improved total adhesive coat weights (shown in the “T CW” column of table 100C) versus two layers of adhesive associated with the conventional single pass systems. For example, the best total coat weight, for a conventional single pass system, results in an approximate adhesive coat weight of 8-12 gsm whereas three adhesive layers associated with the first configuration of system 100A results in an approximate adhesive coat weight of 14-20 gsm and four adhesive layers associated with the second configuration of system 100A results in an approximate adhesive coat weight of 18-24 gsm.

The transfer coefficient increases between the first and second layers of adhesive as evidenced by the illustrated increases in coat weights following the second application of adhesive. This enhanced coefficient it also evidenced by the illustrated increases in coat weights following the third and fourth applications of adhesive in table 100C. This means that more adhesive is transferring from the printing elements on to the web substrate when a second or third or fourth (and so on) adhesive layer is deposited onto the web substrate.

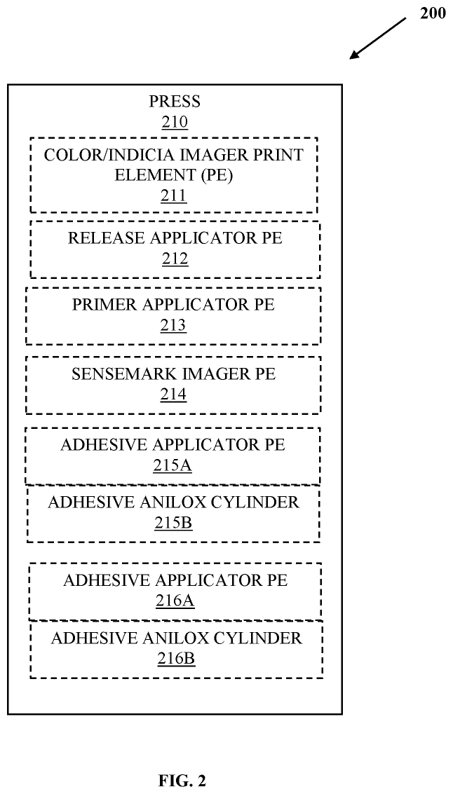

FIG. 2 is a diagram 200 of a press 210 for the system of FIG. 1A or the system of FIG. 1B, according to an example embodiment. The press 210 is station #3 105, station #4 106, station #5 107, station #6 108, station #7 109, or station(s) #8-#N 110 of system 100A or system 100B.

The press 210 includes a color/indicia imager print element 211, a release applicator print element 212, a primer applicator print element 213, a sense mark image printer element 214, an adhesive applicator print element 215A, and an adhesive applicator print element 216A. When the press 210 is configured to deposit more than two adhesive layers on the backside of the web substrate, the stations 214 and/or 213 will be configured like station 215A or 216A.

In an embodiment, the adhesive applicator print element 215A or 216A is a stamp wheel, a flexographic cylinder, an anilox cylinder, a roller, a rotary or flatbed screen, or a gravure print cylinder. In an embodiment, system 100A and/or system 100B is a modified press. In an embodiment, the press is a Cerutti press modified for the two-pass configuration of system 100A. In an embodiment, the press is a press modified with additional stations as illustrated in system 100B for a single pass of the web substrate to achieve three or more layers of adhesive on the backside of the web substrate.

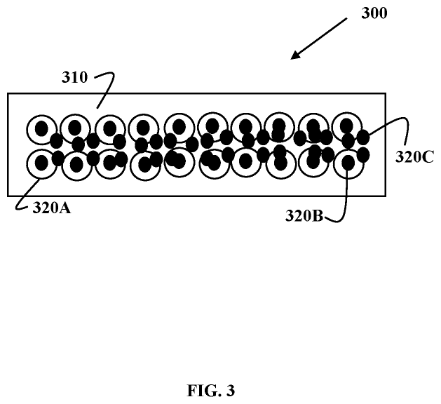

FIG. 3 is a diagram of a backside 310 of a label 300 with an increased adhesive coat weight produced by the system 100A or the system 100B, according to an example embodiment. In an embodiment, label 300 is a linerless label.

Label 300 includes at least three layers of adhesive, a first layer 320A, a second layer 320B applied atop of the first layer 320A, and at least one additional and third layer 320C applied atop of the first layer 320A and/or the second layer 320B. The layers 320A-320C exhibit increased bonding strength characteristics from that which is associated with a single layer of adhesive or two layers of adhesive. The increased bonding strength is achieved by an increased coat weight because of the increased adhesive transfer coefficient produced during manufacturing of label 300 with system 100A and/or system 100B.

In an embodiment, the adhesive deposited in at least three layers is a microsphere adhesive. In an embodiment, the adhesive is a non-microsphere adhesive. In an embodiment, the adhesive is a mixture of two or more different adhesives. In an embodiment, each layer of deposited adhesive is of a same adhesive. In an embodiment, at least two of the three layers of adhesive are of different adhesives or different adhesive mixtures.

In an embodiment, the adhesive is deposited on the backside of the substrate associated with the label 300 in the layers within a pattern as an adhesive patch. In an embodiment, the pattern is of continuous adhesive. In an embodiment, the pattern is of discontinuous adhesive. In an embodiment the adhesive is flood coated on the backside of the substrate in the layers.

By stacking two or more layers of adhesive on the backside of an adhesive-based product's substrate (i.e., web substrate, label substrate, or roll substrate) during manufacture of the products, the anilox cylinders and printing elements of adhesive stations along with the substrate exhibit a rate of increased adhesive transfer coefficient over the adhesive transfer coefficient between first layer of adhesive and the substrate. The increased rate of adhesive transfer coefficient means that the resulting rate of increase in adhesive coat weight from the second adhesive layer to the third adhesive layer remains at the higher rate of increase adhesive coat weight seen between the first and second layers of adhesive. As a result, an adhesive-based product manufactured with at least three layers of stacked adhesive exhibits superior adhesive bonding strength to surfaces over that which is capable with an adhesive-based product manufactured with two or less layers of adhesive.

The three or more layers of adhesive are deposited on the web/label substrate during manufacturing which performs two passes on an existing and modified press, such as system 100A. The manufacturing is also achieved via a modified press with additional stations, such as system 100B.

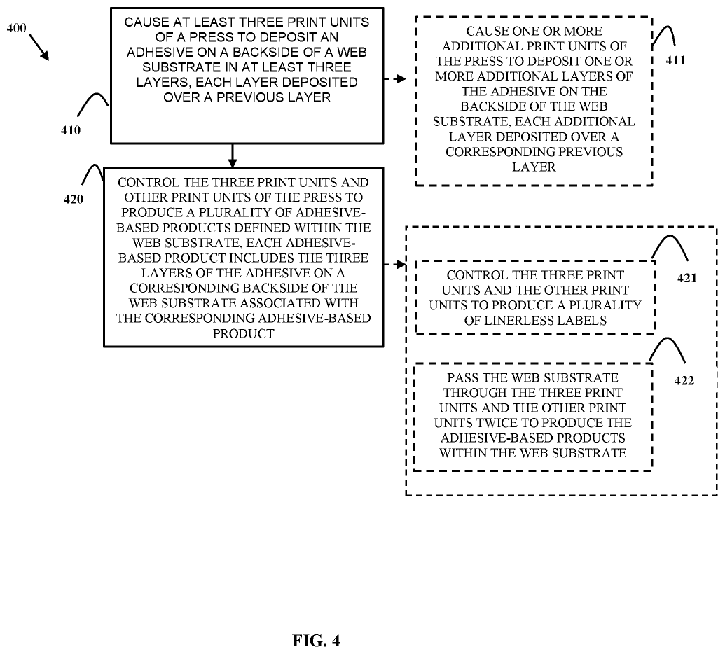

FIG. 4 is a diagram of a method 400 for manufacturing adhesive-based products with an increased adhesive transfer coefficient and thus a higher adhesive coat weight, according to an example embodiment. The method is implemented on a press through firmware that controls electro-mechanical components of the press to manufacture a roll of linerless labels 310. A processor associated with the firmware/software executes instructions to perform the method and to control the electromechanical components of the press.

In an embodiment, the press is system 100A and/or system 100B. The press at least includes stations 103-108, optionally includes stations 109 or 110. Each press 210 is associated with manufacturing a specific component of linerless labels 310. The roll includes a web of a label substrate or a web substrate that is unwound and passed through the stations 103-110 and rewound into a roll of the labels. Each role includes a plurality of instances of linerless labels 310 defined within the corresponding roll. The processor executes the instructions of the firmware/software to cause the corresponding electromechanical components of a given press 210 to add the corresponding specific component to the labels of the roll. The specific components added to the labels 310 at the press 210 include, by way of example only, at least three layers of stacked adhesive deposited on the backside of the labels 310.

At 410, the processor of the press causes at least three print units or stations (106, 107, and 108; 105, 106, 107, and 108; 105, 106, 107, 108, 109; of 105, 106, 107, 108, 109, and 110), of a press (i.e., configured in system 100A and/or 100B) to deposit an adhesive on a backside of a web substrate in at least three layers. Each layer deposited over a previous layer of the adhesive, such that there are bumps of adhesive or stacked layers of adhesive.

In an embodiment, at 411, the processor of the press causes one or more additional print units or stations (108; 108 and 109; or 108, 109, and 110) of the press (i.e., configured in system 100A and/or 100B) to deposit one or more additional layers of the adhesive on the backside of the web substrate. Each additional layer deposited over a corresponding previous layer.

At 420, the processor of the press controls the three print units and other print units of the press to produce a plurality of adhesive-based products defined within the web substrate. Each adhesive-based product include three or more layers of the adhesive on a corresponding backside of the web substrate associated with the corresponding adhesive-based product. In an embodiment, at least one of the print units is controlled by the processor to define each of the adhesive-based products via sense marks imaged or printed on the backside of the substrate.

In an embodiment, at 421, the processor of the press controls the three print units and the other print units to produce a plurality of linerless labels 310. That is, the adhesive-based products are linerless labels 310. The three or more adhesive layers on the backside of the labels 310 exhibit superior bonding strength to adhere to object surfaces.

In an embodiment, at 422, the processor of the press passes the web substrate through the three print units and the other print units twice (i.e., two passes) to produce the adhesive-based products within the web substrate. This was discussed in detail above with the two configurations of system 100A.

In an embodiment, the processor of the press passes the web substrate through the three print units and the other print units once (i.e., single pass) to produce the adhesive-based produces within the web substrate. This was discussed in detail above with the single pass on the web substrate of system 100B.

Although the present invention is described with reference to certain preferred embodiments thereof, variations and modifications of the present invention can be affected within the spirit and scope of the following claims.

1. A system, comprising:
print units adapted to image, print, and deposit coatings on a substrate;
wherein at least three print units adapted to deposit at least three layers of an adhesive on a backside of the substrate, wherein at least three layers are stacked on top of each other on the backside, wherein at least three layers at least include a first adhesive layer, a second adhesive layer stacked on top of the first adhesive layer, and a third adhesive layer stacked on the second adhesive layer;
wherein a rate of increase in a coat weight for the adhesive achieved after the third adhesive layer is deposited atop the second adhesive layer remains at a previous rate of increase achieved when depositing the second adhesive layer atop the first adhesive layer, and wherein the rate of increase is achieved for each additionally adhesive layer deposited atop a previous adhesive layer beyond the third adhesive layer.

2. The system of claim 1, wherein the print units include six print units and wherein the substrate is passed through the print units twice to obtain the at least three layers of the adhesive on the backside of the substrate.

3. The system of claim 1, wherein the print units include seven or more print units and wherein the substrate is passed through the print units once to obtain at least three layers of the adhesive on the backside of the substrate.

4. The system of claim 1, wherein a first print unit is adapted to print or image custom indicia or color on a front side of the substrate, wherein a second print unit is adapted to deposit a release coating on the front side of the substrate.

5. The system of claim 4, wherein a third print unit is adapted deposit a primer coating on the backside of the substrate, deposit the first adhesive layer on the backside of the substrate, or print or image sense marks on the backside of the substrate, wherein the sense marks delineate areas within the substrate associated with individual adhesive-based products along a web of the substrate.

6. The system of claim 5, wherein a fourth print unit is adapted to deposit the first adhesive layer on the backside of the substrate, deposit the second adhesive layer on the backside of the substrate, or print or image the sense marks on the backside of the substrate.

7. The system of claim 6, wherein a fifth print unit is adapted to deposit the first adhesive layer on the backside of the substrate, deposit the second adhesive layer on the backside of the substrate, or deposit the third adhesive layer on the backside of the substrate.

8. The system of claim 7, wherein a sixth print unit is adapted to deposit the second adhesive layer on the backside of the substrate, deposit the third adhesive layer on the backside of the substrate, or deposit a fourth adhesive layer on the backside of the substrate.

9. The system of claim 8, wherein a total adhesive coat weight on the backside of the substrate after the fourth adhesive layer is deposited on top of the third adhesive layer by the sixth print unit is approximately 18-24 gsm (grams per square meter).

10. The system of claim 8, wherein a total adhesive coat weight on the backside of the substrate after the third adhesive layer is deposited on top of the third adhesive layer by the fifth print unit or by the sixth print unit is approximately 14-20 gsm (grams per square meter).

11. The system of claim 1, wherein each of the at least three print units include an anilox roller and a print element.

12. The system of claim 11, wherein print element includes a stamp wheel, a flexographic cylinder, an anilox cylinder, a roller, a rotary or flatbed screen, or a gravure print cylinder.

13. A label, comprising:
a substrate; and
a first layer of an adhesive deposited on a backside of the substrate;
a second layer of the adhesive deposited over the first layer of adhesive; and
a third layer of the adhesive deposited over the second layer of adhesive.

14. The label of claim 13 further comprising:
one or more additional layers of the adhesive, each additional layer of the adhesive deposited over a previous deposited layer of the adhesive.

15. The label of claim 13, wherein the label is a linerless label.

16. The label of claim 13, wherein the label is defined by sense marks within a web of the substrate, wherein the web is wound into a roll and includes a plurality of additional labels.

17. A method, comprising:
causing at least three print units of a press to deposit an adhesive on a backside of a web substrate in at least three layers, each layer deposited over a previous layer; and
controlling the at least three print units and other units of the press to produce a plurality of adhesive-based products defined within the web substrate, each adhesive-based product includes the at least three layers of the adhesive on a corresponding backside of the substrate associated with the corresponding adhesive-based product.

18. The method of claim 17, wherein causing further includes causing one or more additional print units of the press to deposit one or more additional layers of the adhesive on the backside of the substrate, each additional layer deposited over a corresponding previous layer.

19. The method of claim 17, wherein controlling further includes controlling the at least three print units and the other print units to produce a plurality of linerless labels.

20. The method of claim 17, wherein controlling further includes passing the web substrate through the at least three print units and the other print units twice to produce the adhesive-based products within the web substrate.
